(19) United States
(12) Patent Application Publication
(10) Pub. No.: US 2007/0133643 A1
(43) Pub. Date: Jun. 14, 2007

(54) Effective excitation, optical energy extraction and beamlet stacking in a multi-channel radial array laser system

(76) Inventor: Herb Joseph John Seguin, Edmonton (CA)

Correspondence Address: HERB JOSEPH JOHN SEGUIN, 12639-52 AVENUE, EDMONTON, AB, T6H 0P6, CA

(21) Appl. No.: 11/299,175

(22) Filed: Dec. 12, 2005

(51) Int. Cl. H01S 3/04; H01S 3/22; H01S 3/09

(52) U.S. Cl. 372/69; 372/34; 372/55

(57) ABSTRACT

A laser device is comprised of multiple RF excited, diffusion-cooled slab-geometry laser-gain-channels all mounted in a radial-array configuration to provide a multi-channel laser system capable of both high average and peak laser output power, in a extremely small, lightweight and relatively low cost physical package, ideally suited to robotic applications. The concept utilizes a simple and effective methodology for multiple beamlet coupling and stacking which collectively yield a composite laser output beam of excellent efficiency, stability and optical quality.

### FIELD OF THE INVENTION

This invention relates to recent advances in the technology for practical excitation and optical energy extraction in a multi-channel laser system. The methodology features a simpler and more efficient means for the generation and stacking of the multiple-beamlets produced in a radial-array geometry, for either gas or solid-state. As such, the methodology permits a newer generation of very compact and relatively low cost, high power industrial lasers, ideally suited to robotic applications.

### BACKGROUND OF THE INVENTION

There has been persistent pressure in the manufacturing community to adopt more cost-effective technology in order to remain competitive internationally. This aspect is particularly relevant in the automotive industry where the lowering of capital equipment costs and the reduction of component production cycle times can greatly influence a corporation's profit margin. As a result of this situation, several firms over the past decade have found it beneficial to increasingly integrate laser-materials-processing methodology into their manufacturing business.

A major goal here has been the interface of high power lasers with small industrial robots to achieve faster and more flexible production sequences. Some initial success has been achieved by combining lower power YAG lasers having fibre-optic delivery or medium power CO² lasers with conventional robots. The challenge now has become the development of a new generation of lower-cost and good-quality high power industrial lasers, which are sufficiently small and lightweight to permit, mounting on smaller, higher speed robots.

Gas-Transport Laser Technology:

High power industrial lasers have historically employed large-volume discharge-pumped, gas-gain-media, convection-cooled by rapid gas-transport, to achieve the large amount of active-material necessary for multi-kilowatt operation. This fast-flow, single-gain-section approach has however proven to be difficult to implement effectively.

Difficulties arise from the large physical size, with concomitant complexity and cost, in both the excitation and waste-heat extraction systems. Another concern has been the progressively degrading laser output beam symmetry and uniformity, resulting from non-uniformities and/or instabilities in the gain-media; which are intrinsic to large single-volume devices at the required power loading. As a result, the efficiency and effective application of gas-transport lasers is often compromised. Such applications include precision cutting and welding materials-processing sequences, and particularly in robotic situations where excessive size, weight and complexity usually preclude their use altogether.

Many similar difficulties apply to high power solid state lasers, where uniformity in both the extended active-media itself, as well as its' optical pumping and cooling, become exceedingly difficult to achieve, as the size of the single-volume solid state gain- material increases.

Difussion Cooled (Slab) Laser Technology:

As a consequence of the problems encountered with convection-cooled devices, the laser industry has increasingly abandoned gas-transport technology in favour of a diffusion-cooled approach. The concept features a reduction, by about two-orders-of-magnitude, in the width of the laser-gain-media volume. The approach becomes particularly effective when the cross-section of the resulting gain-channel is designed to have a very narrow-width-to-height ratio (SLAB profile). Utilization of a slab geometry yields improvements in both uniformity and stability in gain-media excitation and so promotes increased laser efficiency and reliability.

Slab geometry also permits a major simplification in the waste-heat extraction system via diffusion cooling. Indeed, a diffusion-cooled, slab-laser has no moving parts and a physical size very much smaller than a convection-cooled machine. As such, it is inherently more cost-effective than a conventional device, which invariably requires a costly cooling system.

Single-slab diffusion-cooled methodology for gas lasers is well known in the art and a number of such devices are available commercially. Although, solid-state single-slab lasers have also been advanced in the scientific literature there has thus far been little commercialization of the concept.

Multi-Channel, Radial-Array-Slab-Geometry:

Unfortunately, at still higher output power levels single-slab diffusion-cooled devices are still prone to the non-uniformity and instability problems inherent to all large, single-volume or single-area, gain-sections under high specific power loading. Because of this fact, extension of a single-slab diffusion-cooled approach to very high power lasers has also been problematic. To mitigate these difficulties in single-slab devices and address the higher power regime, researchers have begun to embrace a multi-channel-slab concept.

This alternative approach embodies the creation of numerous parallel, but independent, gain channels, which are subject to simultaneous excitation and optical energy extraction. Implementation of the concept has permitted achievement of the elevated optical output energy levels desired and in even smaller packages. A still more recent advancement of this multi-channel-slab concept, featuring a Radial-Array-Slab geometry, has yielded a significant further reduction in physical size and weight, thereby making such devices well suited to robotic application.

An additional advantage derivable from a radial-array-slab approach is the attainment of even higher quality optical output at elevated power levels, through a beneficial beamlet-stacking phenomenon. When appropriately implemented, the method effectively smoothes-out any non-uniformities in the individual channels through an averaging process; thereby contributing to significant improvements in spatial and temporal uniformity with concomitant increased stability of the composite-laser-output-beam

A specific implementation of this approach for both gas and solid state lasers has been the multi-channel, radial-array-slab concept described in detail by this present author in previous patents entitled; #1: “Laser System With Multiple Radial Discharge Channels”, U.S. Pat. No. 5,029,173, July 1991; #2: “Multi-Slab Solid State Laser System”, U.S. Pat. No. 5,210,768, May 1993; #3: “Excitation System for Multi-Channel Lasers”, U.S. Pat. No. 5,648,980, July 1997; and #4: C.I.P. “Excitation System for Multi-Channel Lasers”, U.S. Pat. No. 5,689,523, Nov. 1997.

### SUMMARY OF THE INVENTION

The patents listed above outline the general radial-array concept, but do not reveal a practical way to realize an industrially viable radial-array-slab laser system The object of this patent disclosure is therefore to teach recent advances and extensions of this unique technology, which permit the development of simpler and more cost-effective laser machines particularly well suited to industrial robotic applications. FIG. 1 is a pictorial illustration of such a new high power multi-kilowatt radial-array laser interfaced with a small, high-speed robot; thereby yielding a relatively low-cost laser-material-processing-system having wide potential usage in present-day manufacturing.

Radial-Array Geometry:

In one embodiment, there is provided a laser system in which multiple longitudinal channels of narrow-gap, diffusion-cooled, laser-gain-media are arranged and uniformly disposed azimuthally about and extending radially from a first common central axis, thereby yielding the radial-array depicted in FIG. 2. The laser-gain-media contained within each of the multiple channels has a narrow width-to-height rectangular cross-section (large aspect ratio) and an axial-length much greater than either cross-sectional dimension, thereby constituting a slab (2) of active media.

These multiple slab-gain-channels may be either a gas or solid and are each bounded on their narrow azimuthal dimension by an adjacent means (4) for providing both pumping and cooling of the laser-gain-media contained therein, The radial-slab-array thus formed is mounted and contained within a hermetic laser-vessel (6) of tubular geometry. Such hermetic laser vessel has a second common central axis co-incident with the first common central axis and is designed to be both mechanically and thermally stable and thereby additionally serves as mounting apparatus for the optical extraction system affixed thereto.

Radial-Array Excitation:

When the slab laser-gain-media is a gas such as, [Co², CO, Excimer, etc.], the means for pumping and cooling are adjacent plural-pairs of pie-shaped metallic electrodes. In one embodiment these pie-shaped electrode are made from extruded Aluminium, all having a thin but very strong dielectric coating. Each of these plural-pairs of electrodes in the array is independently internally water-cooled and electrically excited by RF energy derived from a single high-power RF source. High power RF sources suitable for such slab-laser excitation are well known in the art.

In a further embodiment, the means for independent RF excitation of the electrode pairs in the radial array is achieved by concomitant plural-pairs of low-impedance magnetic-loops mounted within and uniformly azimuthally disposed about the short-circuited end of a quaterwavelength coaxial RF resonant cavity. This RF resonant cavity means is formed between inner and outer concentric metallic cylinders having a third common central axis coinciding and symmetric with both the first and second common central axes.

The inner metallic cylinder of said RF resonant cavity means also serves as the outer water-cooling jacket for the aforesaid tubular hermetic laser vessel, which encloses the radial-array. Alternate plural-pairs of magnetic-loops are cross-interconnected and appropriately feed-through the enclosing laser vessel to provide a sequential but independent positive plus negative polarity RF drive for each electrode-pair azimuthally around the electrode array. Said RF drive establishes multiple but independent narrow-gap gas-discharges between said electrodes.

In the event that the slab laser-gain-media is a solid such as: Nd-YAG, Nd-Glass, GSGG, GGG, Alexandrite, etc., then the adjacent means for pumping and cooling are multiple extended arrays of light-emitting diodes (diode bars) mounted in close proximity to each surface of the individual solid-state gain-channels. These diode bars are in turn electrically driven and water-cooled by external means, all of which are well known in the art. Additional cooling of the solid-state gain-slabs may be achieved through circulation of an appropriate low-optical-loss cooling-fluid throughout the laser enclosure vessel.

Radial-Array Optical Energy Generation:

Optical energy is generated within the radial-array by an optical cavity means having a fourth common central axis coincident with the first, second and third central common axes and is uniformly disposed azimuthally about and co-axially with the multiple slab-gain-channels. Said optical cavity means thereby creates a common optical resonator mode for all of the multiple slab-gain-channels in the radial-array.

Such common optical cavity means constitute 2 low-loss optical reflectors (optical-resonator-mirrors), each mounted axially, at either extremity of the slab-gain-channel radial-array, upon the hermetic ceramic laser vessel. This ceramic containment vessel means is water-cooled and thereby serves as a mechanically and thermally stable optical bench for the optical-resonator-mirror means mounted thereupon. The resonator mirrors means have profiled surface curvatures, reflectivities and coupling appropriately designed and manufactured to establish a common optical resonator mode for all of the slab-gain-channels simultaneously. This common resonator mode means may be either stable or unstable and also may be Toric, the principles all of which are well known in the scientific literature.

Radial-Array Optical Energy Extraction & Combining:

The optical cavity means further incorporates an optical energy extraction means to provide independent optical output coupling from each of the gain-channels simultaneously. Specifically, the common optical-resonator-mirror means additionally features an integrated soft-edge-focusing-skimmer means, which yields optical energy extraction in the form of multiple, demagnified, small-diameter-beamlets, one from each slab-gain-channel in the array.

In a further embodiment, the optical resonator mirror means may also incorporate a multiple beamlet-collimator means together with a divergence-driven beamlet-stacking means. With said beamlet-stacking means each of the small diameter beamlets extracted from all of slab-gain-channels simultaneously are expanded, via propagation with natural-divergence, and then subsequently superimposed upon each other.

Consequently, this multiple beamlet-stacking means inherently provides both a spatial and temporal beamlet-averaging-effect and thereby produces a single, larger-diameter, composite-laser-output-beam of good optical quality and stability. If desired, the multiple-beamlet expansion process via natural-divergence may be supplemented by forced-optical-expansion, through an appropriate focal length modification to the beamlet-collimator means.

In a still further embodiment, the beamlet-skimmer and beamlet-collimating means may be designed with Toric curvatures featuring different effective focal properties in radial and azimuthal planes, so as to provide beamlet non-unity aspect-ratio compensation. A comprehensive computer simulation followed by extensive experimental data has documented that best beam quality is more easily achieved when the aspect-ratio of the individual beamlets is appropriately compensated to be near unity before being expanded and then finally overlapped and thereby combined to yield a composite-laser-output-beam. Aspect-ratio compensation becomes even more beneficial when the beamlets are non-phase-locked.

The optical cavity means may also incorporate a composite-laser-output-beam collimating means featuring a large diameter, low-loss, fully transmitting optical element for non-phase-locked composite laser output beam extraction. Additionally, said optical collimating means may incorporate a partially reflecting optical element to provide the low-level of optical resonator feedback required to achieve phase-locked composite laser output beam extraction.

It is therefore provided in this inventive disclosure majorly improved collective means for multi-channel excitation, optical energy extraction and beamlet combining in a newly developed, simplified and complementary radial-slab-array geometry. The approach yields a uniquely smaller and more cost-effective laser system particularly amenable to robotic utilization.

Such a situation, illustrated in FIG. 1, depicts a new generation of unusually small 5 Kilowatt radial-slab-array lasers interfaced with an equally small commercially available robot, which together yield a fully flexible, high-speed laser-materials-processing system. As such, this package is well suited to a broad spectrum of industrial processes such as; cutting, welding, heat-treating, paint stripping, etc., all which are typically encountered in the modern manufacturing community.

### BRIEF DESCRIPTION OF THE FIGURES

There will now be provided preferred embodiments of the invention, with reference to the figures by way of illustration, and in which figures like references denote like features and in which:

FIG. 1, is an illustration of a new 5-kilowatt radial-slab-array laser mounted onto a small high-speed robot to provide a fully flexible laser materials processing system suitable for diverse industrial applications.

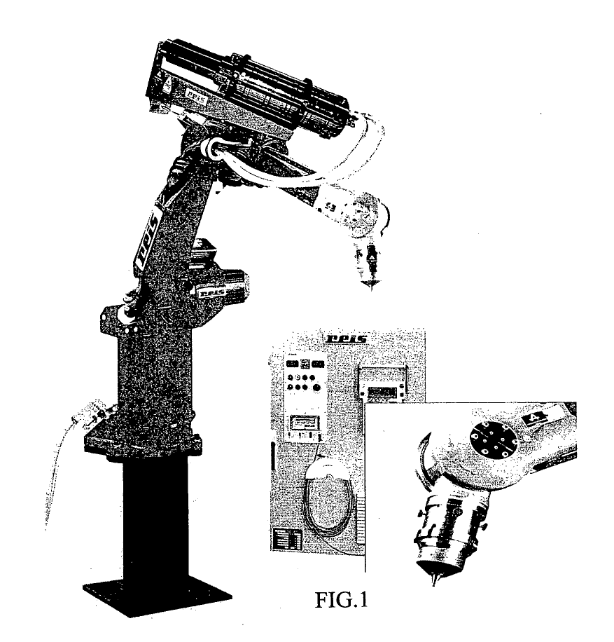

FIG. 2, is a sectional schematic of a radial-slab-array laser system featuring multiple narrow-gap channels of either gas or solid-state gain-media with concomitant adjacent subsystems for pumping and cooling of the individual slabs of laser-gain-media.

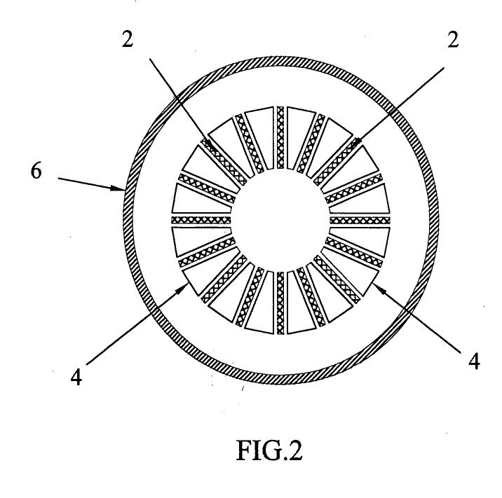

FIG. 3, is a cross-sectional schematic drawing of a multi-kilowatt radial-array-slab carbon dioxide gas laser featuring 24 independent slabs of gain-media each of which is bounded by a water-cooled, dielectrically-coated, metallic electrode-pair; each pair of which is in-turn independently excited by RF energy, all the RF energy of which is derived from a single high power RF generator.

FIG. 4, is a full sectional assembly drawing of an RF excited, Diffusion-cooled, multi-kilowatt radial-array-slab carbon dioxide laser in which all of the electrode elements of said slab-array are mounted upon and contained within a hermetic ceramic vessel. Said electrode elements are heavily cooled via numerous internal water passages and independently electrically driven with RF energy from a surrounding RF resonant cavity by means of multiple magnetic coupling loops. The RF resonant cavity is in turn driven by a single high power RF source. Output laser energy is extracted as a composite beam comprised of multiple stacked beamlets having near 100% overlap, via a Toric optical resonator system featuring water-cooled, low-loss, MMR coated metallic mirrors.

FIG. 5A, is an enlarged partial front-sectional drawing view of the multi-kilowatt radial-array-slab laser illustrated in FIG. 4.

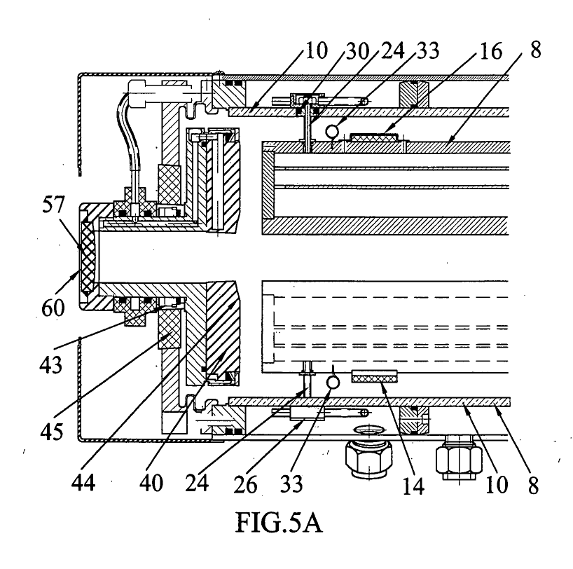

FIG. 5B, is an enlarged partial mid-sectional drawing view of the multi-kilowatt radial-array-slab laser illustrated in FIG. 4.

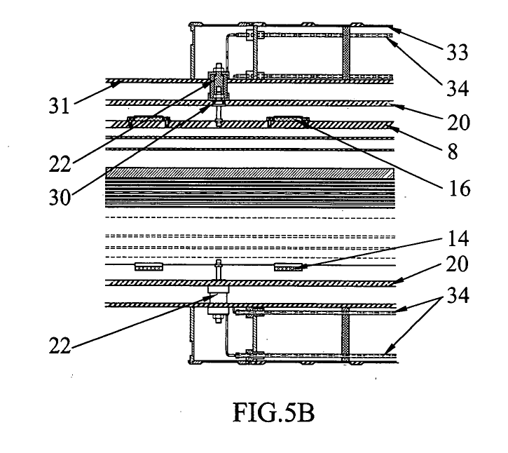

FIG. 5C, is an enlarged partial back-sectional drawing view of the multi-kilowatt radial-array-slab laser of FIG. 4.

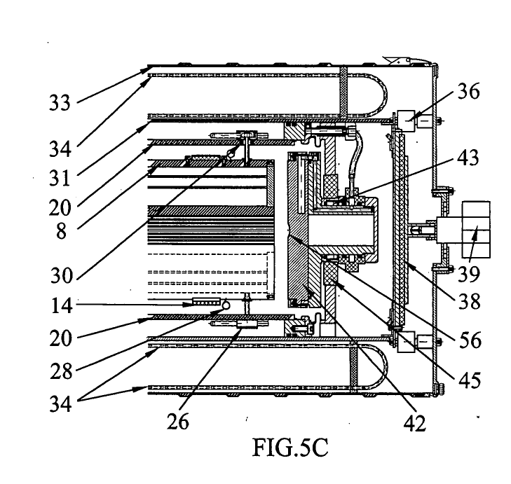

FIG. 6, is a schematic ray-diagram of a Toric optical resonator designed with an integrated focusing-skimmer and a diamond output window to provide multiple beamlet optical energy extraction along the centreline with negligible diffractive loss; and having a external larger diameter beamlet bundle collimating element which yields a composite laser output beam in the form of an annulus.

FIG. 7, is a computer simulation, backed by extensive experimental data,showing the M² quality of the composite laser output beam as a function of the beamlet stacking density parameter (r/a) and for a specific beamlet aspect-ratio (a/b).

FIG. 8, is schematic ray-diagram of a Toric optical resonator designed with an integrated focusing-skimmer, a diamond output window plus an external off-axis parabolic collimator for the small diameter beamlet bundle extracted from the slab-array; followed by a turning mirror and a larger diameter collimator for the divergence-driven and fully-overlapped composite laser output beam.

FIG. 9, is a schematic ray-diagram of a modified Toric optical resonator featuring bothan integrated focusing-skimmer and internal retro-reflective beamlet collimator plus a larger diameter collimating optical output window for either phase-locked or non-phase locked fully-overlapped composite output beam extraction. For phase-locked operation the collimating output window is designed to be partially reflecting, so as to provide the optical feedback required for such operation.

FIG. 10, is a schematic ray-diagram of the modified Toric optical resonator shown in FIG. 9, but now having the common focal point of the beamlet focusing-skimmer and collimator outside of the laser-gas-media.

FIG. 11, is a schematic ray-diagram of an unstable optical resonator designed with both an intergrated focusing-skimmer, a toroidal beamlet collimator, an axicon coupler and a diamond output window; followed by a larger diameter collimating optical element to provide a divergence-driven and fully-overlapped, phase-locked composite laser output beam.

### DESCRIPTION OF PREFERRED EMBODIMENTS

Radial Electrode Array:

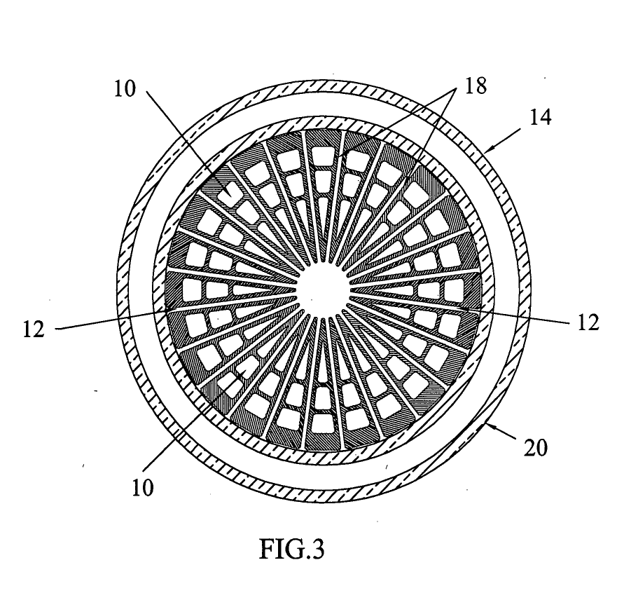

It is provided herein by way of illustration in FIGS. 3 & 4 & 5 typical design and constructional elements of a 5-kilowatt, RF-excited, radial-array-slab, carbon dioxide laser. As described in the previous patents listed herein, the essential aspect of the system is the electrode array, comprised of numerous, relatively long, pie-shaped metallic elements (8). The longer the electrodes the greater is the laser output power.

These electrodes are preferably made from Aluminium extrusions having many internal water-cooling passages (10). The individual electrode elements are mounted in a radial geometry featuring a very narrow-gap (12) of typically 2 mm width. Electrode mounting is afforded via several ceramic rings (14) and retaining clips (16) appropriately situated along and affixed to the back of each extruded element.

Having a small thickness but large surface area, these internal water-cooling passages (10) facilitate rapid metal-to-water heat transfer. Consequently, the electrode elements in the array provide efficient cooling for the multiple RF-excitated, narrow-gap, gas-discharge slab-laser-gain-media contained between them, via a simple diffusion-heat-transfer mechanism. Diffusion-cooled laser methodology is well known and practised in the art.

Waveguide & Free-Space Modes:

It is well known in classical optics that when a laser beam of a specific wavelength λ passes through a constraining structure having width (w), height (h) and length (l) the FRESNEL number (F) controls the type of propagation that is achieved. This important parameter is defined as:
F=(b/2)²/(λl)
where b is the structure dimension perpendicular to the direction of propagation. If the dimensions of the structure are such that F is less than 1 then the beam interacts with the structure walls and propagation becomes a waveguide mode. Conversely, if F is greater than 1 there is little if any beam-wall interaction and propagation becomes a free-space mode.

Typical slab dimensions for the high power radial-array lasers of interest here are: w=2 mm, h=50 mm and l=500 to 1000 mm and so the slab-aspect-ratio=h/w=25. It follows from these dimensions and the above equation that the radial slabs can support 2 different orthogonal modes of propagation. Specifically, in the azimuthal plane b=w, where w is the narrow-gap slab width. Consequently, F is less than 1 and thereby implies beam propagation is via a waveguide mode. However, in the radial plane b=h, where h is the relatively large slab height. Thus, F is now greater than 1 and so the structure supports only a free-space mode of propagation radially. The large slab-aspect-ratio and the concomitant 2 different modes of propagation are of major significance in the optical energy extraction features and beam quality of these slab-array lasers, as is discussed later herein.

The Aluminium electrode elements in the array are also coated with a thin but very strong dielectric material having high thermal conductivity. Said dielectric coatings (18) are preferably about 1/20 mm in thickness and are derived by an electro-chemically induced surface-transformation process. A simple such process known industrially as BRIGHT DRIP anodizing is a well known metallurgical art.

It is important to note here that dielectric coating of the electrodes is essential for proper operation of the laser, both in terms of high power RF excitation and optical energy extraction. Specifically, the dielectric coatings prevent all non-uniform oxidation of the Aluminium electrode surfaces and thereby suppress any glow-to-arc transitions within the narrow-gap gas discharges, even under very high RF power loading. These coatings also suppress any polarization preference within the multiple optical waveguides. These important aspects are more fully addressed at appropriate points in this presentation.

Ceramic Laser Vessel & Optical Bench:

The radial-slab-array is centrally mounted and contained within a water-cooled ceramic laser-vessel (20). This laser containment vessel is preferably made from a thick wall Alumina (AL₂O₃) tube. With an unusually low thermal expansion coefficient but relatively high thermal conductivity, this very strong and extremely rigid Alumina containment vessel also serves as an excellently stable-optical-bench for mounting the optical resonator system components described subsequently herein.

Independent water-cooling and RF drive for each individual electrode element in the array is achieved by means of specially machined, O-ring-sealed, feedthrough assemblies affixed at strategic axial locations along each electrode's back surface. As is evident from FIG. 3 & 4, there are 2 types of feedthroughs in the array. One type, located at the electrode's mid-plane (22) is used for RF drive; while 2 others (24) positioned near each electrode-end, provide water-cooling.

High impedance water resistors (26) are included at each water inlet and outlet to provide electrical isolation, thereby negating any RF losses through the cooling system. In a higher power modification, the central RF feedthroughs are designed to also serve as the water-cooling outlets.

Special transmission line matching inductors (28), are connected along the back of each electrode element to yield a uniform RF voltage distribution along the array. The precise value and specific mounting locations of these matching inductors are determined via a special electromagnetic transmission line computer code.

The feedthrough assemblies are realized by first diamond-core-drilling and polishing corresponding mounting holes in the ceramic laser vessel and then compressing soft O rings (30) to give the required hermetic seal. This soft-O-ring seal on the feedthroughs provides another useful feature as it easily accommodates any axial variations in the physical length of the Aluminium electrode elements, which may arise due to any changes in the laser's excitation or optical extraction levels.

Consequently, these devices do not require a warm-up-period to mechanically stabilize the optical extraction system and so are amenable to truly rapid on-off performance. RF drive energy is thus only required for the exact duration of each particular laser materials processing sequence. This feature is in contrast with most other laser systems, which usually need continuous energy drive to achieve stability in optical output power level and beam quality. It follows from this scenario, that highly-repetitive, short-duration, manufacturing processes such as tailor-blank cutting, spot-welding, hole cutting and drilling etc., become more cost-effective when the laser can be operated in a truly on-off manner.

Another very important benefit derived from using a ceramic such as Alumina for the containment vessel is that it is an excellent electrical insulator. As such, it provides full RF isolation of each electrode element in the array from the rest of the laser system. This aspect means that all RF discharge corona from either the backs of the electrodes or the water-cooling and RF feedthroughs, which plague most other RF Excited laser designs, is completely eliminated. This feature translates into further increased electrically efficiency and thermal stability of the laser system.

Quater-Wavelenght Resonant RF Cavity:

In order to derive the full benefit of high power operation from a multi-channel laser system it is essential that each gain channel be independently RF driven. It follows that each electrode element in the radial slab array must then effectively have its' own RF source which does not interact with any other. Although in principle, this condition can be realized by using many independent RF generators, the approach is not practical or cost-effective. However, as outlined in previous patent No. 2, utilization of a half-wavelength electromagnetic resonant RF cavity provided a convenient solution.

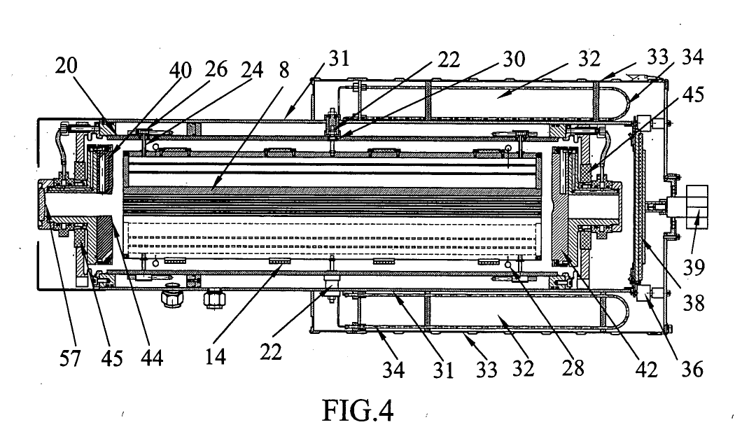

Item (32) in FIGS. 4 & 5 depicts a greatly improved quarter-wavelength resonant electromagnetic cavity method developed for driving this new laser system. This cavity is comprised of inner (31) and an outer (33) co-axial metallic cylinders. In this geometry, multiple low-impedance magnet-loops (34) are used to couple equal amounts of circulating RF energy out of the main RF cavity and then independently impress this energy into each gain channel at its' mid-point.

This results in the production of multiple slab discharges, which do not interact electrically, even at very high RF power loading. Use of a quarter-wavelength resonant electromagnetic cavity also yields a simpler, smaller and lighter overall system, requiring only 1 RF feedthrough per electrode element.

Giant-Spike Optical Performance:

A quarter-wavelength cavity approach also permits increased capacitive-loading of the RF resonant cavity, which in turn yields a concomitant increased RF energy storage capability within the cavity. This feature, accomplished through the use of multiple and evenly distributed, low-loss RF tuning capacitors (36), has been shown to be particularly attractive under pulsed laser operation. Specifically, when the laser is driven by a pulsed RF energy source, via RF energy input coupling capacitors (38) and RF input connector (39), considerable RF energy is stored in the electromagnetic cavity, during the short period between the beginning of the RF drive pulse and just before the initiation of the pulsed gas discharge.

With the very low-impedance magnet-loop coupling used herein this transiently stored RF energy provides a major increase in the near-instantaneous but short-duration electrical pumping of the slab-gain-channels, once gas discharge breakdown has occurred. This gives rise to a significant gain-switched pumping phenomenon. The effect is the generation of a Giant-Spike of optical laser radiation, having an order-of-magnitude increase in amplitude but very short duration, of typically 500 nanoseconds, on the leading edge of every pulse; much like a TEA Laser optical output, featuring both very fast rise-time and short duration. This giant-spike on the leading edge of each laser pulse has been shown to be particularly effective for rapid piercing of materials and consequently is very beneficial in laser drilling or tailor-blank cutting and also for blind spot or lap-welding procedures.

The specific values of the RF tuning capacitors (36) above are determined with the aid of a special computer program, which solves the electromagnetic equations for a capacitively loaded RF cavity. However, the value of the RF input coupling capacitor (38) was determined experimentally via cold-testing with an RF network analyzer under simulated magnetic loop loading conditions, due to the impedance presented by each electrode-pair under RF drive. The cold-test value of the electrode-pair impedance was previously obtained from another special computer program simulating each electrode-pair and the slab-gas-discharge contained therein as a lossy RF transmission line.

Although these new radial-array-slab lasers may be operated with continuous wave (CW) RF drive the author's research has shown it is more efficient to operate them in a pulsed mode since a more optimum electric-field-to-gas-pressure (E/P) ratio can be achieved in the narrow-gap discharges under pulsed RF drive conditions. Furthermore, CW RF drive does not generate the Giant-Spike characteristic in the laser's output.

Radial Beamlet Coupling & Optical Energy Extraction:

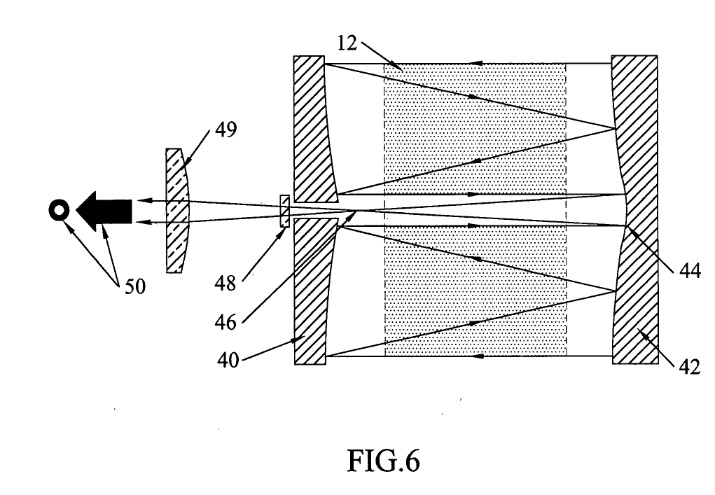

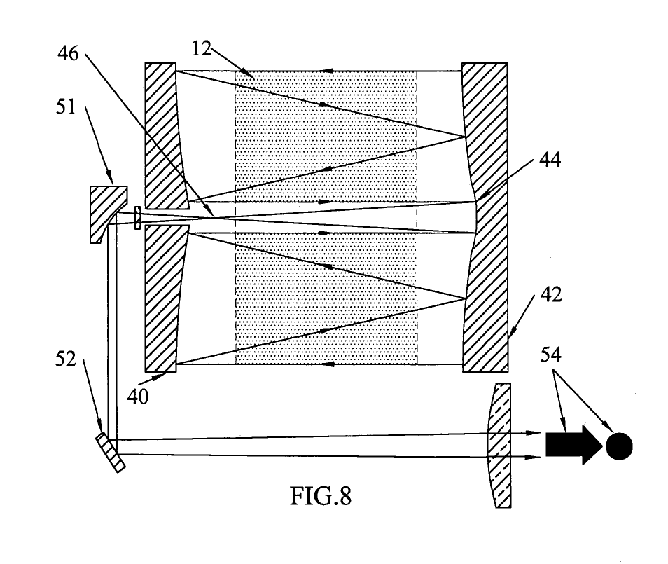

As described previously above, the surfaces of the slab electrodes in the array optically support both waveguide and free-space modes for each-gain channel, which together with the reflectors constitute the optical resonator. The resonator mirrors (40) & (42), also illustrated in FIGS. 4 & 5, are water-cooled metallic reflectors, diamond machined and having low-loss MMR coatings. These mirrors are mounted into special mirror holders (43) via collet-style fixtures, while the mirrors holders are in turn affixed to the stable optical bench provided by the ceramic laser vessel (20). Item (12) in FIGS. 6, 8 & 9, represent the multiple slabs of laser-gain-media in the radial array.

It is further evident that the mirror holders in FIGS. 4 & 5, are designed with insulating ceramic discs (45), whose primary function is to make the mirrors float electrically. This is a most important feature, with respect to the operational lifetime of the resonators mirrors. This follows from the two conditions that; the RF gas discharges within each slab are in reality plasmas having a high positive-ion density; and that the mirror surfaces are mounted very close to the ends of these slabs.

As a consequence of these conditions the mirror surfaces would normally be subject to heavy positive-ion bombardment, leading to rapid mirror reflectivity degradation. However, the new laser design outlined herein incorporates a mirror protective means, which effectively solves this major problem. Specifically, our research has documented that if the mirrors are made electrically neutral, via the insulating discs (45), then they quickly accumulate (float-to) the positive-ion space-charge potential within the slabs. This then repels any further positive-ion bombardment and so the mirror coatings now exhibit an indefinite operational lifetime.

Toric Resonator Laser Energy Extraction:

Although several different optical resonator have been used in the past, a particularly attractive configuration is the Toric resonator shown schematically in FIG. 6. The mirror surface curvatures employed in this embodiment are designed so that multiple optical beams are initiated at the outer periphery of each slab-channel in the array and then propagate as a waveguide mode radially inward towards the centreline, at which point they are subsequently coupled out as beamlets. Because of this waveguide mode of operation in the azimuthal direction, the individual beams are not demagnified as they propagate inwardly, as would normally be the case in an unbounded Toric optical resonator. The specific surface curvatures required for the mirrors used herein were determined with the aid of a computer program, which solves the SIEGMAN propagation equations for a confocal Toric optical resonator.

Further in this context, the degree of beamlet optical coupling C required for proper operation of these lasers was determined via another computer program, which performed a RIGROD analysis on the system. For the multi-kilowatt radial-slab lasers under consideration here having the typical geometrical parameters given previously as: w=2 mm, h=50 mm, l=500 mm, and using the saturation parameter Is=1000 w/cm² previously determined experimentally, this Rigrod analysis gives: C=20%.

With these parameters the beamlet-aspect-ratio (AR) becomes: AR=a/b=hC/w=5. It follows therefore that the beamlets coupled out of a slab in a conventional high powered slab-array laser will generally have a non-unity aspect-ratio and so will not exhibit a circular intensity profile As discussed later in this document, this condition can significantly impact composite laser beam quality.

Unlike the former approach where optical energy extraction was achieved by over-the-edge beamlet walk-off, the Toric resonator system utilized in this new laser features a unique skimmer configuration to provide multiple beamlet extraction. This is a particularly important difference since the older method resulted in the generation of relatively poor quality beamlets; each exhibiting pronounced optical energy distortion and loss, due to the strong diffraction effects characteristic of an over-the-edge output coupling methodology.

Instead, in this new laser design optical output coupling is achieved via an integrated soft-edge focusing-skimmer concept in which the Toric mirror surface curvature near the centreline is modified to permit the multiple beamlets to be coupled out of the resonator without encountering a sharp edge. This feature thereby effectively negates diffraction losses. Specifically, mirror curvature at location (44) is designed to simultaneously focus all the beamlets to a common location along the centreline (46), after which point they are extracted from the laser system via a small diameter optically transmitting window (48).

In this new approach, depicted in FIG. 6, beamlet output coupling from the laser is done relatively close to the common focal point of the skimmer (46). Consequently the local optical intensity may be quite high (approaching ½ KW/mm² in a 10 KW laser). For this reason, the output-coupling window used in this configuration (48) should preferably be made from diamond, which can easily handle optical intensities well above this value without damage or distortion.

Once coupled out of the laser the beamlet bundle continues to expand and is subsequently re-collimated by a lens (49) into a composite output beam (50), comprised of larger diameter beamlets combined into an annular configuration. Experience has shown that although annular laser beams are useful for many industrial processes including welding, they do not yield the narrowest focal-spot sizes generally desired for cutting and drilling sequences.

Output Beam Quality:

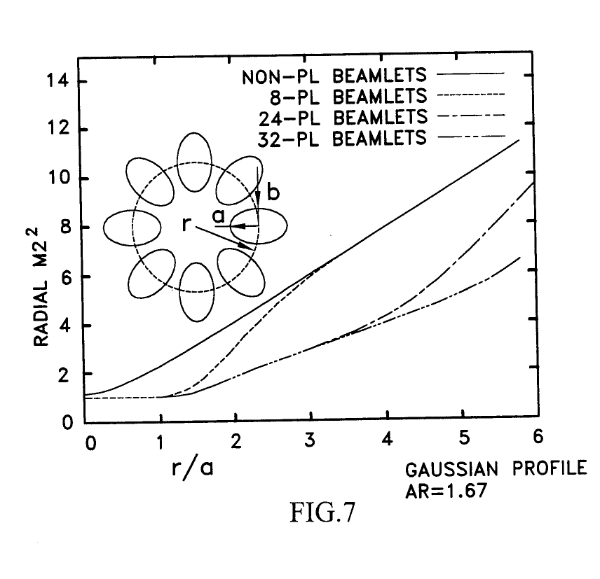

Following the scenario above, it is important here to examine the optical quality of the composite output beam that may be derived from a typical multi-channel radial-slab-array laser. Significant insight into this topic is provided by FIG. 7. This figure is representative of an extensive computer analysis of the effects of combining multiple beamlets into a single composite output beam under a number of different conditions. In particular, this figure shows the beam quality or M² of the composite output beam obtained as a function of the system's optical parameters such as: the number of beamlets, the beamlet aspect ratio (AR=a/b) and the beamlet stacking parameter (r/a), under both phase-locked and non-phase-locked operation. In this context, an M²=1 represents an ideal diffraction-limited laser beam.

Collective examination of FIG. 7 and many additional curves taken for different beamlet aspect ratios reveals that best composite beam quality (lowest M²) is more easily achieved from such a laser when it is designed to satisfy the following conditions:
1. The number of beamlets in the array should be large.
2. The degree of beamlet stacking overlap should be high; thus the stacking parameter (r/a) should be small.
3. The beamlets should preferably be phase-locked.
4. Each beamlet should have an aspect ratio near 1; thus the beamlets should be round before being combined into a single composite output beam.

It is also clear from these curves that good beam quality may be obtained without a high degree of beamlet stacking overlap if the beamlets are phase-locked. However, the data also reveals that almost as good performance can be obtained even without phase-locked beamlets, provided the stacking parameter (r/a) is sufficiently small. The situation where (r/a)=0 implies that all beamlets are perfectly stacked on top of each other and thus represents a 100% overlap condition.

External Beamlet Collimator and Stacker:

It follows from the data and scenario above and that although phase-locked operation of may be preferred, it is not essential provided an appropriate methodology for near 100% stacking overlap is available. A new method recently developed to achieve this important condition is afforded by the external beamlet collimator and stacker shown in FIG. 8. Here the beamlets focused along the centreline (46) and coupled out through a diamond window (48) are collimated by a water-cooled off-axis parabolic reflector (51), turned by mirror (52) and then propagated with natural divergence and allowed to expand and overlap each other and are finally re-collimated by a larger diameter lens (53) into a solid composite output beam (54).

Internal Beamlet Collimator and Stacker:

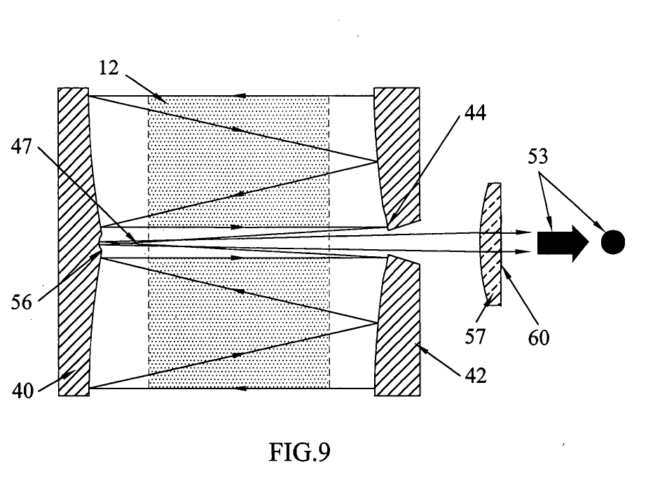

In a still newer and more cost effective approach, the modified Toric system shown in FIG. 9, may be employed for optical energy extraction. Now mirror (42) curvature at position (56) is also redesigned to re-collimate the demagnified beamlets previously focused along the centreline (47) and then retro-reflectively stack them back on top of each other before coupling out of the system. In this simpler method, the ratio of the confocal lengths of (47) and (56) is designed with sufficient beamlet demagnification to provide a concomitant high degree of multiple beamlet-overlap, due to natural divergence, upon subsequent propagation and impingement at the laser's output window (57). Thus, a single composite output beam (58) is again achieved but which is now composed of multiple beamlets having a near 100% stacking overlap.

A very significant further implication of this fact is that the output beam now becomes an average of all of the beamlets generated by the multi-slab array and so becomes extremely insensitive and tolerant to random perturbations or mechanical variations in both the excitation and optical systems. As such, the composite laser output beam exhibits a much-improved spatial and temporal stability, in addition to the better optical quality described above.

Further in this approach, the output window (57) is designed with an appropriate piano-concave lens curvature to provide collimation of the stacked multiple beamlet bundle. An additional important benefit achieved here is that the greatly expanded and well-overlapped beamlet bundle so derived exhibits a sufficiently reduced optical intensity at the output that a regular low-cost window material such as ZnSe may be used instead of a very expensive diamond window.

Non-unity Aspect Ratio Compensation:

In order to further increase the optical power derived from each slab in a radial-slab-array laser one can increase either the length or the height, but not the width, of the electrode elements in the radial array. In this context, our research has shown that from considerations of ease of manufacture and minimum size, it is best not to extend electrode length beyond about 1 meter, but instead to increase the height.

This approach however also increases the aspect ratio of both the individual slabs and their associated beamlets, which as indicated above compromises composite output beam quality. This aspect becomes more evident considering that it is known from classical optics that the spreading of an ideal coherent gaussian beam, due to natural divergence as it propagates, is given theoretically as:
W=(4/π)(λ/DL)
where W is the beamlet's dimension at position L from the exit aperture, λ is the wavelength, and D is the beamlet size at the exit aperture. It follows from this equation that in slab lasers where the beamlet aspect ratio is greater than 1 the output beamlets will expand differently in azimuthal and radial planes as they propagate away from the slab's output aperture. Consequently, in higher-powered lasers it is desirable to provide a beamlet-aspect-ratio compensation feature so that beamlet stacking is done with round beamlets. This condition is easily accomplished with this new optical extraction system by employing appropriate Toric curvatures on both the beamlet's focusing skimmer and collimator.

In this approach the focusing beamlet skimmer mirror surface at position (44) together with the beamlet collimator mirror surface at position (56) are now diamond machined to have slightly different effective focal properties in azimuthally and radial directions so that the beamlet cross-sectional dimensions a & b are equal. This corresponds to the desired condition of unity aspect ratio, (AR=a/b=1).

Phase Locking:

In certain situations it may be desirable to operate such lasers in a phase-locked condition. In this context, the author has previously advanced a number of different approaches to phase-lock the multiple beamlets generated in a radial-array laser, having either an unstable or Toric optical resonator. However, each of these former approaches was difficult and costly to implement. Fortunately, the new laser design and construction geometry presented herein is conducive to a simpler and much improved methodology.

Specifically, phase locking may be achieved in the modified Toric system illustrated in FIG. 9, simply by providing a small amount of simultaneous common optical feedback to all of the slab-gain-channels in the array. This feature is easily accomplished by incorporating a low-loss, partially reflective coating (60) to the outside planar surface of the collimating output window (57), instead of the anti-reflection coating normally applied to such output windows.

In this approach, the reflectivity of this exterior coating is designed to feedback an appropriate percentage, typically around 10 to 20%, of all of the expanded, overlapped and re-collimated beamlets constituting the composite output beam. Each slab-gain-channel is thereby subject to the same optical feedback conditions in: amplitude, polarization and phase, which in turn promote a common phase and polarization throughout.

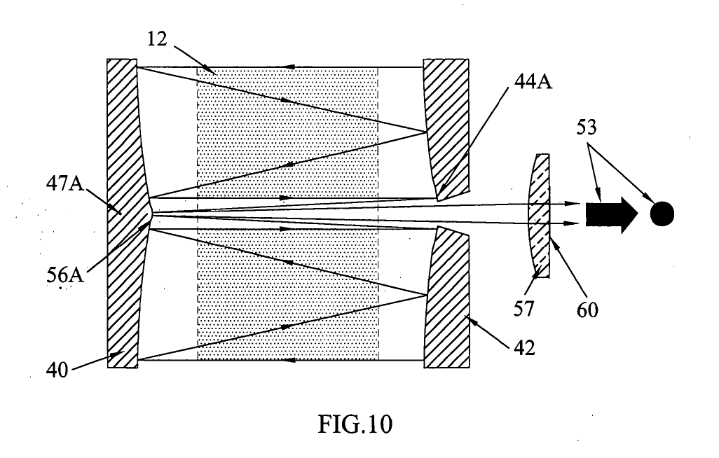

At very high laser power levels it may not be desirable to have the common focal point of the confocal beamlet skimmer and collimator optics inside the laser-gas-media; because of the possibility of optically-induced gas-breakdown. However this potential problem is easily mollified via the simple modification illustrated in FIG. 10. As can be seen, now the focal length of the beamlet focusing skimmer is increased slightly at position (44A) so that the new virtual confocal point (47A) is outside of the laser-gas-media. Also, the corresponding beamlet collimating mirror curvature at position (56A) is made convex. Otherwise the system is identical to that of FIG. 9.

Polarization:

It is important to understand here that to achieve full phase-locked operation with this Toric resonator it is essential that the strong polarization preference, normally characteristic of metallic slab-geometry optical waveguides, be suppressed. Indeed, if this condition is not provided then each slab-gain-channel in the array will operate with its' own independent radial polarization and consequently phase-locking of the array is not achieved.

However, this polarization preference suppression condition has conveniently been achieved in this new laser design by using the Bright Dip dielectric coating (18) referred to earlier in this document. Specifically, our research has shown that when the thickness of the Bright Dip dielectric coating used on the Aluminium electrodes in the radial-slab-array is made an appropriate value then the polarization preference is sufficiently suppressed so that all polarizations are equally viable. Thus, phase-locked operation becomes feasible and the composite laser output beam exhibits all possible polarizations, and thereby becomes non-polarized.

It is of further interest to consider here that in the absence of phase-locking the laser's optical output contains all the radial polarizations collectively generated by the multiple slabs in the array. As such, the output beam from a non-phase-locked device performs effectively the same as a non-polarized laser. In this context, a non-polarized laser beam is usually preferred in most materials processing applications since the laser materials processing parameters become independent of the beam's direction of travel relative to the work-piece.

Unstable Resonator Energy Extraction:

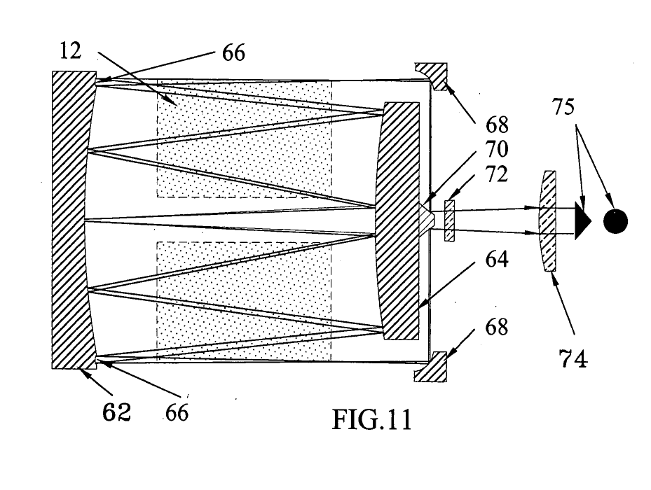

As an alternative to the Toric approach outlined above, the Unstable resonator illustrated in FIG. 11 may be employed for optical energy extraction from this radial-slab-array and for either gas or solid-state gain media. In this embodiment the resonator mirrors (62) & (64) are again water-cooled metallic reflectors with MMR coatings. However, the mirror surface curvatures are now diamond-machined so that the resonator supports a classical free-space unstable optical mode, which is initiated at the centre-line and begins to propagate radially outward. However, upon reaching the interior position of the array this central free-space mode is converted into multiple waveguide optical beams within each individual slab; all of which continue to propagate radially outward.

Upon reaching the outer periphery of the mirrors, the beams within each slab are coupled out as beamlets by a outer annular focusing-skimmer (66). A soft-edge skimmer concept is again employed to prevent beamlet energy loss and distortion due to any sharp mirror edge. The curvature and confocal length of the toroidal collimating reflector (68) are designed such that together with the focusing skimmer (66) and axicon (70) they function to de-magnify, collimate and axially redirect each of the beamlets extracted at the other periphery of the slab array. The demagnified beamlets are then coupled out of the laser via window element (72) then expanded and overlapped via propagation with natural divergence and finally recollimated by a larger diameter lens (74) into the composite laser output beam. (75).

An important aspect of this unstable optical resonator operation is that since the central region of the resonator supports a uniform free-space mode it acts as a core-injection-oscillator for each of the surrounding slab-gain-channels simultaneously. Thus, the entire slab array is inherently self-driven with exactly the same optical amplitude, phase and polarization. This results in complete phase-locking of the entire slab array under all RF drive conditions and at all optical output power levels. The methodology thereby provides a stable, efficient and relatively simple method to achieve a fully phase-locked multi-channel laser system capable of high power performance.

I claim:

1. A laser system comprising:
A radial-array composed of a plurality of slab-gain-channels, each slab of which is elongated in a direction along a first common central axis and having a narrow width in the azimuthal direction and an intermediate height in the radial direction, and containing laser excitation media, said laser excitation media being in the form of either a gas or solid-state laser material; and
attached means for mounting and enclosing each slab-gain-channel in the radial-array and effectively containing therein said laser excitation media; and
means attached to and bounding each slab-gain-channel in the radial-array for effective cooling of the laser excitation media contained therein, either gas or solid-state; and
energy excitation means attached to and bounding each slab-gain-channel in the radial-array for input energy pumping of the laser excitation media contained therein, either gas or solid-state material.
For gas-gain-media such as: carbon dioxide; carbon monoxide; nitrogen; excimer; etc., said attached cooling and excitation means being in the form of a plurality of water-cooled, metallic electrode elements affixed in a radial-array geometry coincident with and bounding said radial-array of gas slab-gain-channels, each adjacent electrode-pair thereby creating a narrow-gap, RF-excited, gas-discharge configuration and thereupon providing means for input energy pumping for each slab of gas-gain-media contained therein; and
said attached means for input energy pumping of the multiple-slab gas-gain-media being in the form of RF energy coupled from a co-axial quarter-wavelength resonant RF cavity having a second central axis coincident with the first common axis and circumvolving said radial-array of slab-gain-channels; and
said RF energy coupling means from the quarter-wavelength resonant RF cavity means being in the form of a plurality of low-impedance magnetic-loops mounted within and uniformly disposed azimuthally around the short-circuited end-face and of said RF resonant cavity; and
said low-impedance magnetic-loops being connected to the mid-point of each metallic electrode element in the radial electrode array, thereby providing, independent and efficient RF excitation of the narrow-gap gas-gain-media bounded by each electrode-pair in the array; and
attached optical energy extraction means for laser energy extraction from the plural slabs of gas laser excitation media, said optical energy extraction means featuring an optical resonator having a third common central axis coincident with the first and second common central axes and thereby providing simultaneous optical energy extraction in the form of multiple beamlets, one from each slab of gas laser excitation media in the radial array, said beamlets of which are subsequently combined and coupled out the laser system.
For solid-state gain-media such as: Nd-YAG; Nd-glass; GSGG; GGG; Alexandrite; etc., said attached means for cooling and input energy pumping being in the form of a plurality of water-cooled, light-emitting diode-bars affixed in a radial-array geometry coincident with and bounding said radial-array of solid-state slab-gain-channels, each adjacent pair of diode-bars thereby providing a short-path but large surface area for uniform optical pumping of each slab of solid-state gain-media so bounded; and
attached optical energy extraction means for laser energy extraction from the plural slabs of solid-state laser excitation media, said optical energy extraction means featuring an optical resonator having a third common central axis coincident with the first and second common central axes and thereby providing simultaneous optical energy extraction in the form of multiple beamlets, one from each slab of solid-state laser excitation media in the radial array, said beamlets of which are then combined and coupled out the laser system.

2. The gas-laser system of claim 1 in which the excitation means for the gas-laser-gain media contained within the slab channels is composed of plural pairs a metallic electrodes manufactured from extruded pie-shaped Aluminium elements having numerous internal water-cooling passages and such plural pairs of electrodes are all mounted with a narrow-gap and in a radial array configuration coincident with the plural slab-gain-channels; via ceramic rings and clips disposed along the electrode array's length; and in which
said pie-shaped Aluminium electrodes are each coated with a thin but very strong dielectric material, such coating preferably being produced by the electro-chemical process generally known as Bright Dip anodizing, and said dielectric coating having a thickness sufficient to suppress the polarization preference characteristic of metallic waveguides.

3. The laser system of claim 2 in which said radial electrode array is in turn affixed co-axially with and mounted and contained within a water-cooled and electrically insulating dielectric hermetic laser vessel, such laser vessel being manufactured from a physically strong and thermally stable ceramic material such as Alumina; and
such radial electrode array mounting being afforded by multiple hermetically sealed RF and water-cooling feedthroughs, strategically affixed at positions corresponding to the midpoint and both ends of each electrode element comprising the array; and in which
said ceramic hermetic laser vessel also serves as a mechanically and thermally stable optical bench for mounting the optical resonator components, which collectively comprise the optical energy extraction means of the laser system.

4. The laser system of claim 3 in which each electrode-pair element in the radial array is independently driven by an RF energy coupling means from an electromagnetic quarter-wavelength resonant RF cavity means mounted co-axially with and circumvolvingly containing said radial electrode array; and
said independent RF energy coupling means being provided by a multiplicity of low-impedance magnetic loops uniformly azimuthally disposed and mounted into the short-circuited end of said quarter-wavelength resonant RF cavity and then affixed to the midpoint of each electrode-pair element via appropriate RF feedthroughs; and in which
each electrode-pair has RF transmission-line matching inductors affixed at appropriate locations along the electrodes' back surfaces, to provide a uniform RF voltage distribution along the length of the electrode-pair, thereby generating a uniform RF excited discharge within the narrow-gap slab-gas-gain-media contained therein; and
the precise inductance value and mounting locations of said matching inductors being determined by an Electromagnetic RF transmission-line computer simulation program developed specifically for this purpose.

5. The laser system of claim 4 in which the quarter-wavelength resonant RF cavity means is formed by a pair of concentric metallic cylinders mounted coaxially with and circumvolvingly containing the ceramic hermetic laser vessel; the inner cylinder thereby also serving as the cooling-jacket for said laser vessel; and
the short-circuited end of said RF resonant cavity serving as the mounting plane for the multiple low-impedance magnetic coupling loops uniformly disposed around the end-plane circumference; and
the open-circuited end of said RF cavity serving as means for RF input energy drive to the overall laser system, such input RF energy drive means being derived from a single high power RF energy source operating at an appropriate RF frequency in the VHF band and preferably around 100 MHZ.

6. The laser system of claim 1 in which the optical energy extraction means is provided by a pair of Toric optical reflectors, having an optical axis coincident with the radial-slab-array axis and further having the surface curvatures and reflectivities of which are designed and manufactured to support a Toric optical resonator mode; and in which
said Toric optical resonator mode produces multiple optical beams, (one within each slab-gain-channel), which are each initiated at the outer periphery and then propagate inward towards the centreline; and in which
such multiple optical resonator beams, when extracted from each slab-gain-channel by an optical energy extraction means, generate a multiplicity of optical beamlets, which are subsequently coupled out of the laser system.

7. The laser system of claim 6 in which the optical energy extraction means features a soft-edge focusing-skimmer means, having a geometry and surface curvature necessary to provide multiple beamlet energy extraction without diffractive loss and such that all beamlets are focused to a common point along the laser's centreline, either inside or outside of the laser-gas-media; then coupled out of the laser and re-collimated, via an output window and lens means.

8. The laser system of claims 6 & 7 in which the multiple beamlets extracted from each slab-gain-channel and then coupled out of the laser, are collimated, propaged, expanded and stacked upon themselves by an external beamlet collimating and stacking means, having an optical axis coincident or independent of the optical resonator axis; and
said external beamlet collimating and stacking means having a confocal demagnification ratio sufficient to provide near 100% beamlet overlap for the composite laser output beam via propagation with natural divergence.

9. The laser system of claim 8 in which the composite laser output beam, composed of the multiple beamlets stacked with near 100% overlap, is subsequently re-collimated via a large diameter plano-concave lens means.

10. The laser system of claims 6 & 7 in which the multiple beamlets extracted from each slab-gain-channel and then focused to a common point along the centreline by the soft-edge focusing-skimmer means are collimated, reflected back upon themselves and expanded by an internal beamlet collimating and retro-reflecting stacking means, having an optical axis coincident with the optical resonator axis; and
said internal beamlet collimating and retro-reflecting stacking means having a confocal demagnification ratio sufficient to provide near 100% beamlet overlap for the composite laser output beam via propagation with natural divergence along the optical resonator axis inside the laser chamber.

11. The laser system of claim 10 in which the composite laser output beam, composed of the multiple beamlets stacked with near 100% overlap, is subsequently re-collimated via a large diameter piano-concave lens means, and said lens means of which further serves as the output window means for the laser system.

12. The laser system of claim 11 in which the re-collimating plano-concave output window means is made with a low-loss partially reflecting coating which generates sufficient collective optical feedback for each slab-gain-channel in the radial-array to provide phase-locking of all said gain-channels simultaneously.

13. The laser system of claim 10 in which the soft-edge skimmer means and internal beamlet collimating and retro-reflecting stacking means are designed with Toric curvatures to provide beamlet non-unity aspect-ratio compensation.

14. The laser system of claim 1 in which the optical energy extraction means is provided by a pair of unstable optical reflectors, having an optical axis coincident with the radial-slab-array axis and further having the surface curvatures and reflectivities of which are designed and manufactured to support a Unstable optical resonator mode; and in which
said unstable optical resonator mode produces multiple optical beams, (one within each slab-gain-channel), which are each initiated and phase-locked by self-injection at the inner slab position by the free-space core-oscillator and then propagate outward towards to the outer periphery and in which
such multiple optical resonator beams, when extracted from each slab-gain-channel by an optical energy extraction means, generate a multiplicity of optical beamlets, which are subsequently coupled out of the laser system.

15. The laser system of claim 14 in which the optical energy extraction means features a soft-edge annular focusing-skimmer means, having a geometry and surface curvature necessary to provide multiple beamlet energy extraction without diffractive loss and such that all beamlets are focused to an annulus at the laser's outer periphery then de-magnified, redirected and collimated, via an internal torroidal reflector means; and in which
said multiple demagnified and collimated beamlets redirected by the torridal reflector are coupled out of the laser via an internal axicon and output window means, then propaged, expanded, stacked upon themselves then re-collimated by an external beamlet stacking and re-collimating means, having an optical axis coincident or independent of the optical resonator axis; and in which
said internal and external beamlet demagnification, stacking and collimating means collectively have an effective confocal demagnification ratio sufficient to provide near 100% beamlet overlap for the composite laser output beam via propagation with natural divergence.

16. The laser system of claim 15 in which the soft-edge annular skimmer means and internal beamlet demagnification and collimating means are designed with Toric curvatures to provide beamlet non-unity aspect-ratio compensation.

17. The solid-state laser system of claim 1 in which the optical energy extraction means has an optical axis coincident with the radial-slab-array axis and further has the surface curvatures and reflectivity of which are designed and manufactured to support a Toric optical resonator mode; and in which
said optical resonator mode produces multiple optical beams (one within each slab-gain-channel), which are each initiated at the outer periphery and then propagate inward towards the centreline; and in which
such optical resonator beams, when extracted from each slab-gain-channel by an optical energy extraction means, generate a multiplicity of optical beamlets, which are then coupled out of the laser system.

18. The solid-state laser system of claim 17 in which the optical energy extraction means features a soft-edge focusing-skimmer means, having a geometry and surface curvature necessary to provide multiple beamlet energy extraction without diffractive loss such that all beamlets are focused to a common point along the laser's centreline; then coupled out of the laser and re-collimated via an output window and collimating lens means.

19. The laser system of claim 18 in which the multiple beamlets extracted from each slab-gain-channel and then coupled out of the laser are collimated, propagated, expanded and stacked upon themselves by an external beamlet collimating and stacking means, having an optical axis coincident or independent of the resonator optic axis; and
said beamlet collimating and stacking means having a confocal demagnification ratio sufficient to provide near 100% beamlet overlap for the composite laser output beam via propagation with natural divergence.

20. The solid-state laser system of claim 19 in which the composite laser output beam, composed of the multiple beamlets stacked with near 100% overlap, is subsequently re-collimated via a large diameter plano-concave lens means and thereby provides the composite laser output beam.

21. The laser system of claims 17 & 18 in which the multiple beamlets extracted from each slab-gain-channel and then focused to a common point along the centreline by the soft-edge focusing-skimmer means are collimated, reflected back upon themselves and expanded by an internal beamlet collimating and retro-reflecting stacking means, having an optical axis coincident with the optic resonator axis; and
said internal beamlet collimating and retro-reflecting stacking means having a confocal demagnification ratio sufficient to provide near 100% beamlet overlap for the composite laser output beam via propagation with natural divergence along the optical resonator axis inside the laser chamber.

22. The solid-state laser system of claim 21 in which the composite laser output beam is subsequently re-collimated via a large diameter plano-concave lens means, which further serves as the output window means for the laser system.

23. The laser system of claim 22 in which the re-collimating plano-concave output window means is made with a low-loss partially reflecting coating which generates sufficient collective optical feedback for each solid-state slab-gain-channel in the radial-array to provide phase-locking of all said gain-channels simultaneously.

24. The solid-state laser system of claim 21 in which the soft-edge skimmer means and internal beamlet collimating and retro-reflecting stacking means are designed with Toric surface curvatures to provide beamlet non-unity aspect-ratio compensation.

25. The solid-state laser system of claim 1 in which the optical energextraction means is provided by a pair of unstable optical reflectors, having an optical axis coincident with the radial-slab-array axis and further having the surface curvatures and reflectivities of which are designed and manufactured to support a Unstable optical resonator mode; and in which
said unstable optical resonator mode produces multiple optical beams, (one within each slab-gain-channel), which are each initiated and phase-locked by self-injection at the inner slab position by the free-space core-oscillator and then propagate outward towards to the outer periphery and in which
such multiple optical resonator beams, when extracted from each slab-gain-channel by an optical energy extraction means, generate a multiplicity of optical beamlets, which are subsequently coupled out of the laser system.

26. The solid-state laser system of claim 15 in which the optical energy extraction means features a soft-edge annular focusing-skimmer means, having a geometry and surface curvature necessary to provide multiple beamlet energy extraction without diffractive loss and such that all beamlets are focused to an annulus at the laser's outer periphery then de-magnified, redirected and collimated, via an internal torroidal reflector means; and in which
said multiple demagnified and collimated beamlets redirected by the torridal reflector are coupled out of the laser via an internal axicon and output window means, then propaged, expanded, stacked upon themselves then re-collimated by an external beamlet stacking and re-collimating means, having an optical axis coincident or independent of the optical resonator axis; and in which
said internal and external beamlet demagnification, stacking and collimating means collectively have an effective confocal demagnification ratio sufficient to provide near 100% beamlet overlap for the composite laser output beam via propagation with natural divergence.

27. The solid-state laser system of claim 26 in which the soft-edge annular skimmer means and internal beamlet demagnification and collimating means are designed with Toric curvatures to provide beamlet non-unity aspect-ratio compensation.
